(19) United States
(12) Patent Application Publication
(10) Pub. No.: US 2012/0160977 A1
(43) Pub. Date: Jun. 28, 2012

(54) MULTIPURPOSE HOOK

(75) Inventor: Alan WISNIEWSKI, Toronto (CA)

(73) Assignee: UMBRA LLC, Buffalo, NY (US)

(21) Appl. No.: 12/975,633

(22) Filed: Dec. 22, 2010

(51) Int. Cl. F16B 45/00; H01F 7/02

(52) U.S. Cl. 248/304

(57) ABSTRACT

A multipurpose hook having a fragmentary breast member, a head integral with and extending upwardly from the breast member, the head having a face portion, a beak extending outwardly from the face portion, the beak having an upper member and a lower member, the upper and lower members separated by a slit, and a magnet embedded in the face portion adjacent and below the lower beak member.

### FIELD OF THE INVENTION

The invention broadly relates to a multipurpose hook and, more particularly, to a bird-shaped hook with a plurality of means for holding objects, such as memos and other paper items; hangable items, i.e., purses, necklaces, etc.; and magnetic materials, i.e., key rings, pens, etc.

### BACKGROUND OF THE INVENTION

Multipurpose hooks are well known articles of manufacture, which provide a person with several ways to hold multiple objects. Generally, a multipurpose hook includes a combination of hooks and slits operatively arranged to hang objects and store paper items.

A problem with prior multipurpose hooks is that they generally do not provide a user with means for holding a variety of different types of objects. Many multipurpose hooks allow a person to hang items but do not provide a means for holding paper objects. While a few multipurpose hooks provide a person with a way to hang objects and hold paper items, they do not allow a person a means to hold magnetic items.

Another problem with prior multipurpose hooks is that the hook portion is generally a protrusion extending outward from a decorative body portion of the multipurpose hook instead being aesthetically pleasing by incorporating a functional hook into the decorative body portion.

Thus, there is a long-felt need for a multipurpose hook that includes a hook portion, slit for paper items, and a magnet. In addition, there is a long-felt need for a multipurpose hook that is aesthetically pleasing by including a hook portion that is integral with a decorative body portion.

### BRIEF SUMMARY OF THE INVENTION

The present invention is a multipurpose hook having a fragmentary breast member, a head integral with and extending upwardly from the breast member, the head having a face portion, a beak extending outwardly from the face portion, the beak having an upper member and a lower member, the upper and lower members separated by a slit, and a magnet embedded in the face portion adjacent and below the lower beak member. In a preferred embodiment, the multipurpose hook is bird-shaped and can be made from a variety of materials, such as metal, plastic, wood, etc. The head is angled to support an object draped around it. The fragmentary breast member is substantially spherical in shape and the beak is substantially conical in shape. The multipurpose hook includes an outer backing plate, which is mountable about a planar surface.

A general object of the invention is to provide a multipurpose hook with a variety of means for holding objects, including a hook, slit, and magnet.

Another object of the invention is to provide an aesthetically pleasing multipurpose hook where the hook portion is integral with a decorative body portion.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention in view of the accompanying drawing figures, in which:

FIG. 1 is a perspective view of a preferred embodiment of the present invention, shown holding a variety of objects and secured to a planar surface;

FIG. 2 is a perspective view of present invention, illustrating three different functional applications;

FIG. 3 is a cross-sectional view of the multipurpose hook;

FIG. 4 is a side view of the multipurpose hook;

FIG. 5 is an enlarged side view of area 4 identified in FIG. 4; and,

FIG. 6 is an exploded view of the multipurpose hook.

### DETAILED DESCRIPTION OF THE INVENTION

At the outset, it should be appreciated that like drawing numbers on different drawing views identify identical, or functionally similar, structural elements of the invention. It also should be appreciated that figure proportions and angles are not always to scale in order to clearly portray the attributes of the present invention.

While the present invention is described with respect to what is presently considered to be the preferred aspects, it is to be understood that the invention as claimed is not limited to the disclosed aspects. The present invention is intended to include various modifications and equivalent arrangements within the spirit and scope of the appended claims.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

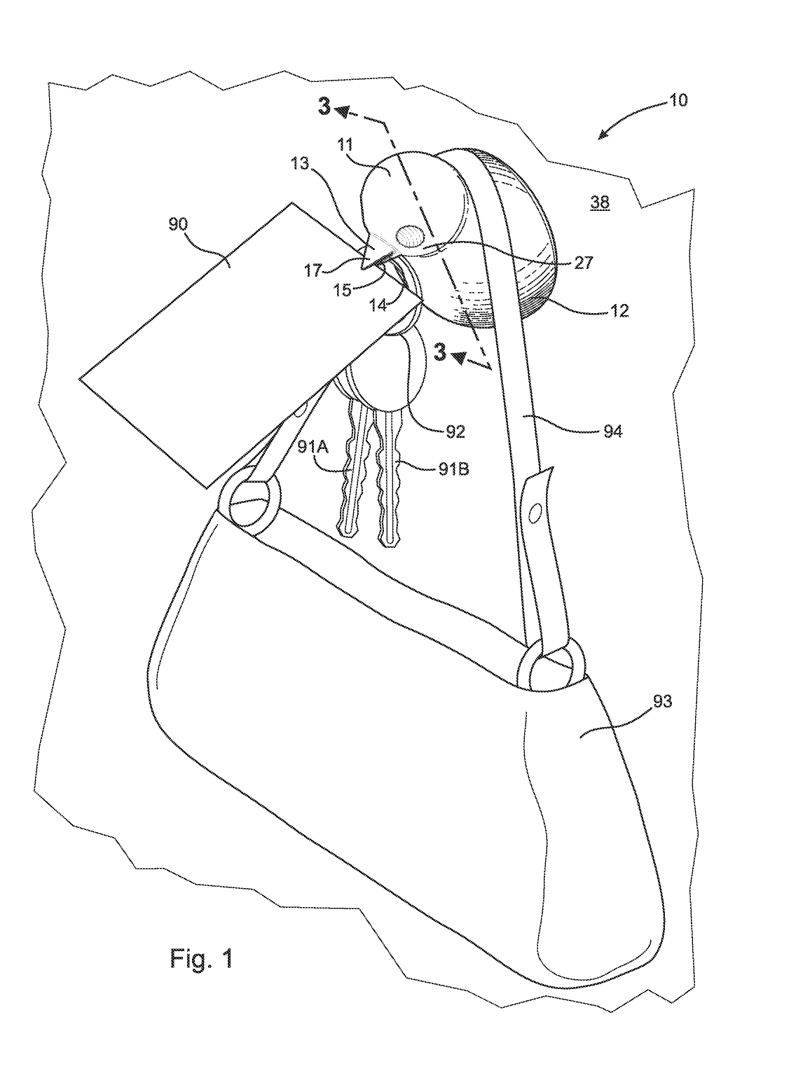

Adverting now to the figures, FIG. 1 illustrates an embodiment of the present invention showing a perspective view of multipurpose hook 10 (hook 10″) broadly comprising fragmentary breast member 12, head 11, and beak 17. Head 11 is integral with and extends upwardly from breast member 12. Head 11 includes face portion 27. Beak 17 extends outwardly from face portion 27. Beak 17 includes upper member 13 and lower member 14. Upper beak member 13 and lower beak member 14 are separated by slit 15. Magnet 16 (not shown in FIG. 1) is embedded in face portion 27 adjacent and below lower beak member 14. Multipurpose hook 10 is mounted to wall 38 via outer backing plate 33 (not shown in FIG. 1). Multipurpose hook 10 is operatively arranged to hold a variety of objects as shown, such as paper 90, keys 91a and 91b, and purse 93.

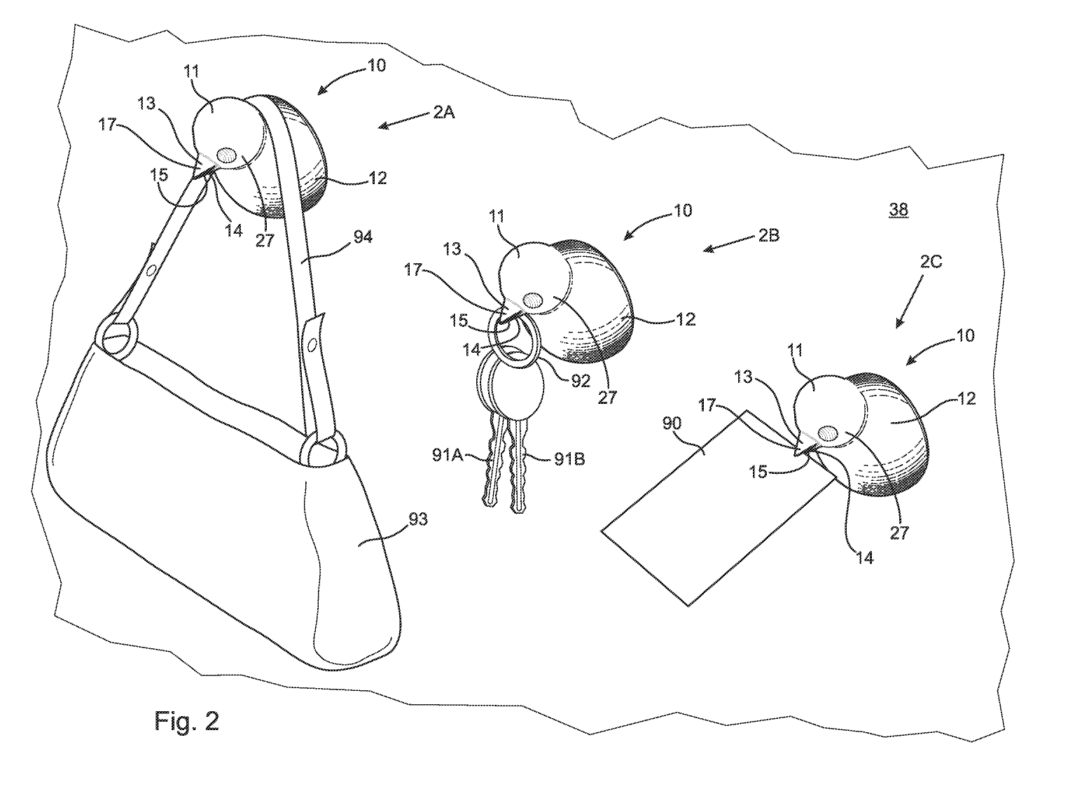

FIG. 2 is a perspective view of the present invention, depicting the three different functional applications illustrated in FIG. 1, shown individually. Purse 93 is shown draped over head 11. Keys 91a and 91b are shown attached to key ring 92, which is hanging from magnet 16 (not shown). Paper 90 is held within slit 15 between upper beak member 13 and lower beak member 14.

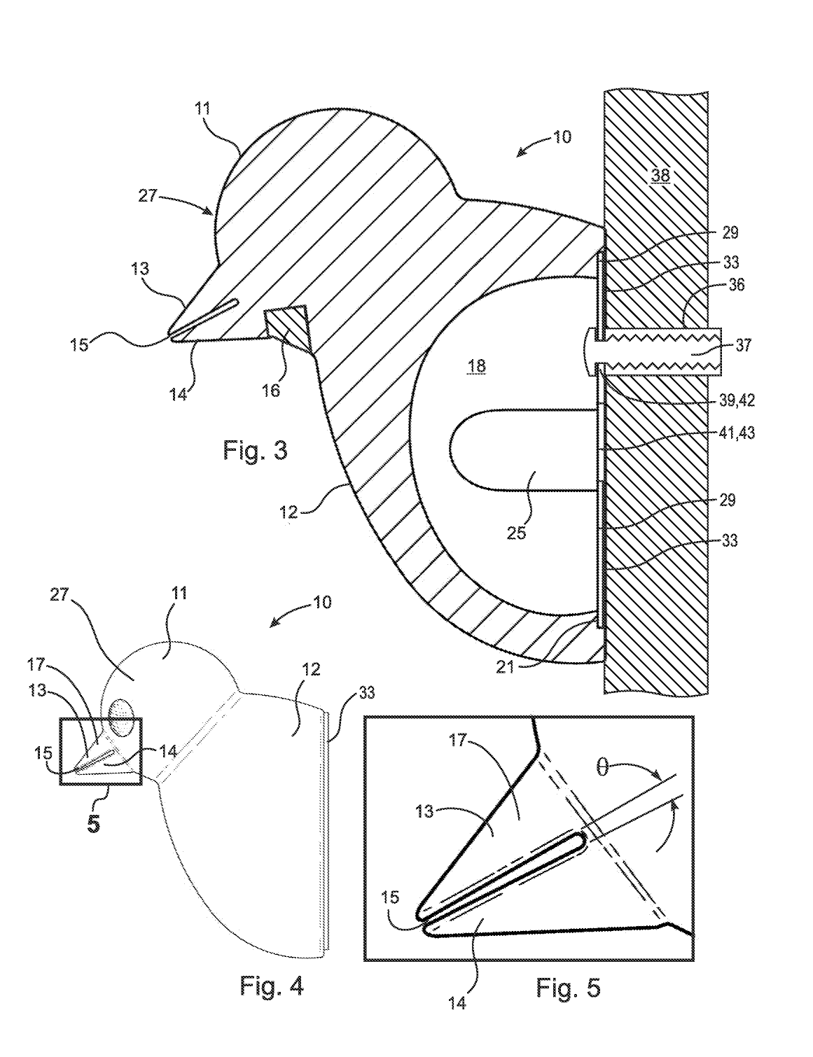

FIG. 3 is a cross-sectional view of the multipurpose hook. Magnet 16 is shown embedded at the lower junction of head 11 and body 12. A portion of magnet 16 is exposed at the surface of hook 10 to enable it to hold ferromagnetic items using magnet force. Upper beak 13 and lower beak 14 bound slit 15.

FIG. 3 also shows how hook 10 is anchored to vertical planar wall 38. Screw compartment 25 (“compartment 25”) is shown formed into a side wall of inner cavity 18. As described below, compartment 25 holds an assembly screw 28 (not shown in FIG. 3). In the preferred embodiment shown in FIG. 3, compartment 25 is enclosed to provide a closed compartment for the assembly screw. Inner backing 29 and outer backing 33 define wall anchor apertures 34 and 35, respectively. In a preferred embodiment, apertures 34 and 35 are keyhole apertures. Screw 37 is shown fitted into the upper portion 39 and 42 of the keyhole apertures 34 and 35. In the embodiment shown, screw 37 is held by wall anchor 36.

FIG. 4 is a side view of head portion 11 showing beak 17 formed by upper beak 13 and lower beak 14. FIG. 5 is an enlarged view of the enclosed area shown in FIG. 4. In the preferred embodiment shown, upper beak 13 and lower beak 14 are positioned to form a tapered slot 15. As can be seen in FIG. 5, angle 0 formed at the inner end of slot 15 is such that the upper side of slot 15 projects toward the lower side to form slot 15 into a tapered shape.

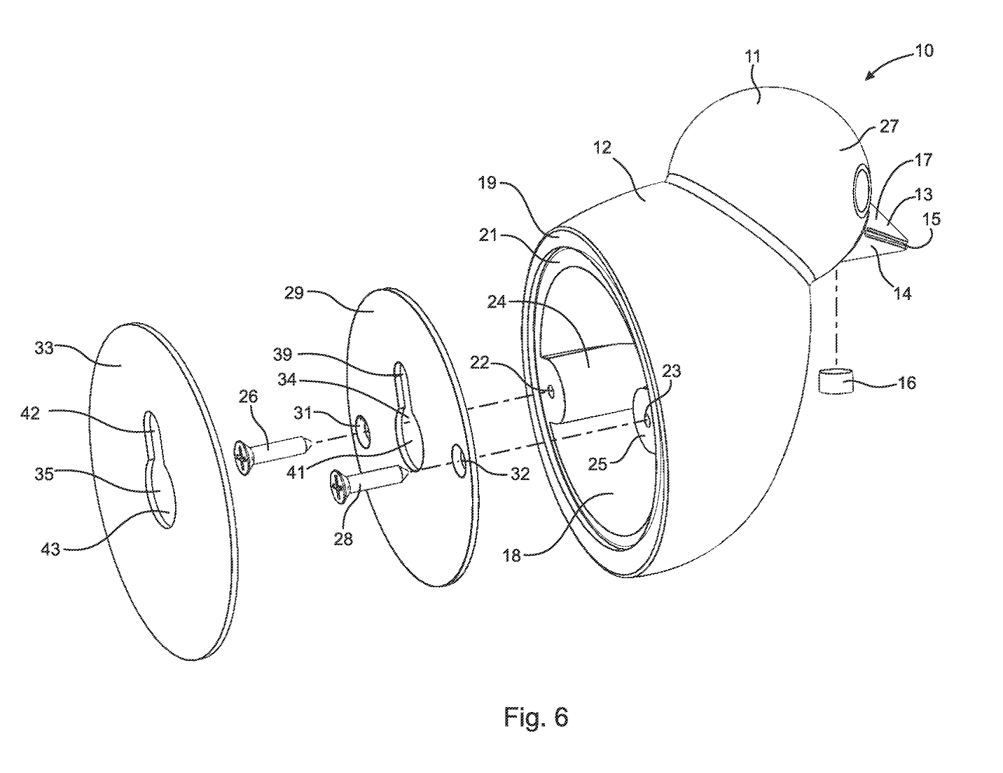

FIG. 6 is an exploded side view of hook 10 that depicts the assembly of hook 10. Head 11 is attached to body 12 at a generally upwardly projecting angle. Because body 12 and head 11 are curved, the attachment point forms a depression or saddle at the junction point suitable to hold a strapped bag as seen in FIG. 2. Inner cavity 18 contains first screw compartment 24 and second screw compartment 25 which provide threaded holes 22 and 23, respectively for screws 26 and 28, respectively.

Inner backing plate 29 (“plate 29”) defines keyhole anchoring aperture 34 (“aperture 34”) as well as screw holes 31 and 32. Preferably screw holes 31 and 32 are countersunk to provide an even back surface on plate 29. Plate 29 forms the inner back wall of hook 10. Preferably, plate 29 fits into inner rim 21 so as to be flush with the edge 19 of hook 10. Outer backing 33 defines an aperture 35 similar size and shape to anchoring aperture 34. In a preferred embodiment, outer backing 33 is fabricated from a smooth and/or soft material such as velvet. Outer backing may be attached to inner backing plate 29 using adhesives, rivets, screws, and other fastening devices well known to those having skill in the art. Persons of skill in the art will recognize that hook 10 may be fabricated form metal, plastic, or other suitable material.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### PARTS LIST

10. Multipurpose hook
11. Head
12. Body
13. Upper protrusion
14. Lower protrusion
15. Slot
16. Magnet
17. Beak
18. Interior cavity
19. Outer rim
21. Inner rim
22. First screw aperture
23. Second screw aperture
24. First screw compartment
25. Second screw compartment
26. First screw
27. Face portion
28. Second screw
29. Inner backing plate
31. First backing plate opening
32. Second backing plate opening
33. Outer backing plate
34. Wall anchor aperture (Inner backing plate)
35. Wall anchor aperture (Outer backing plate)
36. Wall anchor
37. Wall screw
38. Wall
39. Aperture upper portion (Inner backing plate)
41. Aperture lower portion (Inner backing plate)
42. Aperture upper portion (Outer backing plate)
43. Aperture lower portion (Outer backing plate)
90. Paper
91a. Key
91b. Key
92. Key ring
93. Purse
94. Purse Strap

What is claimed is:

1. A multipurpose hook comprising:
a fragmentary breast member;
a head integral with and extending upwardly from said breast member, said head having a face portion;
a beak extending outwardly from said face portion, said beak having an upper member and a lower member, said upper and lower members separated by a slit; and,
a magnet embedded in said face portion adjacent and below said lower beak member.

2. The multipurpose hook recited in claim 1, wherein said multipurpose hook is bird-shaped.

3. The multipurpose hook recited in claim 1, wherein said head is angled to support at least one object draped around said head.

4. The multipurpose hook recited in claim 1, wherein said fragmentary breast member is mountable about a planar surface.

5. The multipurpose hook recited in claim 1, wherein said multipurpose hook is made of metal.

6. The multipurpose hook recited in claim 1, wherein said multipurpose hook is made of plastic.

7. The multipurpose hook recited in claim 1, wherein said fragmentary breast member is substantially spherical in shape.

8. The multipurpose hook recited in claim 1, wherein said head is substantially spherical in shape.

9. The multipurpose hook recited in claim 1, wherein said beak is substantially conical in shape.
